(19) United States
(12) Patent Application Publication
(10) Pub. No.: US 2011/0102165 A1
(43) Pub. Date: May 5, 2011

(54) Taxi-roof sign

(76) Inventor: Avner Rahamim, Kiriat Shmone (IL)

(21) Appl. No.: 12/149,065

(22) Filed: Apr. 25, 2008

(30) Foreign Application Priority Data
Sep. 3, 2002 (IL) 151582

(51) Int. Cl. B60Q 1/00

(52) U.S. Cl. 340/434

(57) ABSTRACT

A taxi sign device, which can display various details is provided; the taxi sign device utilizes the unit which is installed today on the taxi's roof (the yellow hat with the writing “TAXI”) and comprises a keypad or buttons for entering the driver's commands, a control unit controlling the display on the taxi's roof according to commands entered a fixed display which is not changeable for identification, an internal display which allow the driver to see status reports or to see an image of what is shown in the display on the roof; it is possible to also display distress signs and calling for help initiated by the driver.

### CROSS REFERENCE TO RELATED APPLICATIONS

This application claims priority from Israeli Patent Application No. 151582, filed on Sep. 3, 2002 the entire contents of which are incorporated herein by reference.

### BACKGROUND OF THE INVENTION

1. Field of the Invention

The present invention relates to an electronic display device for a taxicab.

2. Description of the Related Art

Today, taxis may operate at certain lines based on a license or an agreement authorizing them to do so. There is a problem of unauthorized taxis operating over these lines as well. An apparent, clearly visible sign alternative of the authorized taxis is required, in order to distinguish them from others, and to enable enforcement means.

An additional problem involves presenting a traveling destination. The destination may change once in a while.

Fixing sign methods, which are customary today, are ineffective—such as a cardboard sign within the taxi, or painting the taxi in a different color. This is ungainly and inconvenient, such as when the taxi's route is changed.

Another problem today involves asking for help, in case of an emergency—such as if the taxi was kidnapped and the driver is driving under a weapon's threat. In this case, the driver cannot cry out for help.

These problems, amongst additional ones, are solved through the sign device, which is described hereinafter.

### SUMMARY OF THE INVENTION

The present invention relates to a taxi sign device.

The device utilizes today's installed unit placed on the taxi's roof (The yellow hat with the writing “TAXI”) as an efficient and apparent, visible display.

The display is digital.

The display is controlled from within the taxi.

The driver can, for example, select a message for displaying, through a keypad.

The system includes an electronic device for operating the display on the roof as requested. It is possible to add a hidden emergency button.

### BRIEF DESCRIPTION OF THE DRAWINGS

FIG. 1 is a block diagram of the taxi sign device

FIG. 2 is the display unit installed on the taxi's roof

FIG. 3 is a front view of the control board for the taxi's digital display

FIG. 4 is a rear view of the control board for the taxi's digital display

FIG. 5 is a top view of the control board for the taxi's digital display

FIG. 6 is a side view of the control board for the taxi's digital display

### DETAILED DESCRIPTION OF THE PREFERRED EMBODIMENTS

The content of Israeli Patent Application (and patent) No. 151582, filed on Sep. 3, 2002, titled “A Taxi-Roof Sign” is hereby provided.

Examples of my invention shall now be described, with reference to the accompanying drawings.

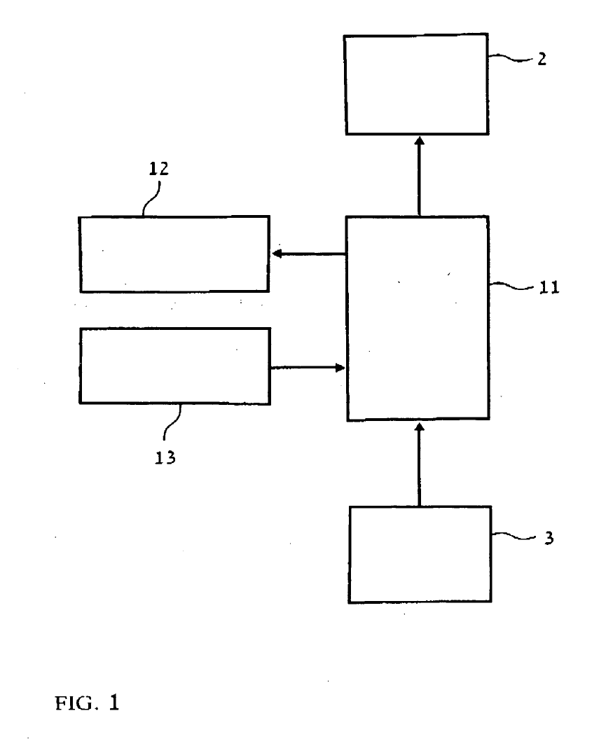

FIG. 1 details a block diagram of a formation of the taxi sign device. The taxi sign device includes a control unit 11, controlling the display on the taxi's roof, a keypad 13 (and/or buttons) for entering the driver's commands, a display for the driver 12, and the display unit 2 installed on the taxi's roof.

The sign device is connected to the vehicle's battery 3 or to other electrical energy source in the vehicle.

The driver within the taxi can control the display on the roof through the keypad 13.

In addition, the driver can see status reports, etc on the internal display in the taxi 12.

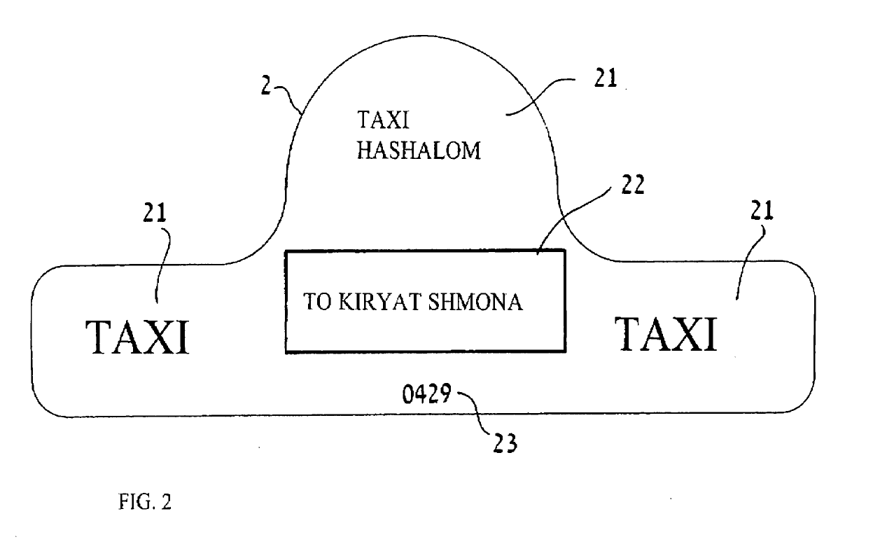

FIG. 2 details the display unit 2 installed on the taxi's roof.

The display unit 2 may include, for instance, a display 21 identifying the vehicle as a taxi, and identification of the taxi's station to which the taxi is related;

Ride's destination 22;

Identification of the taxi carrying this sign 23.

In addition, the display 2 may present distress signs or calling for help indications (not shown in the drawing). Various additional ads may be presented through this display.

It may be possible to use the existing (hat) sign unit, which is installed on the taxi's roof, by adding the digital display connected to the control unit in the taxi.

In another embodiment, a novel sign unit is assembled instead of the hat installed today.

The display 2 is a digital display, and is lighted in the night, and may be lighted also in the day.

In case the display itself is lighting, such as Light Emitting Diode (LED) units, then it is possible not to use additional lighting means.

It is possible to implement the display with various digital display means, such as CRT, Plasma, LCD, etc.

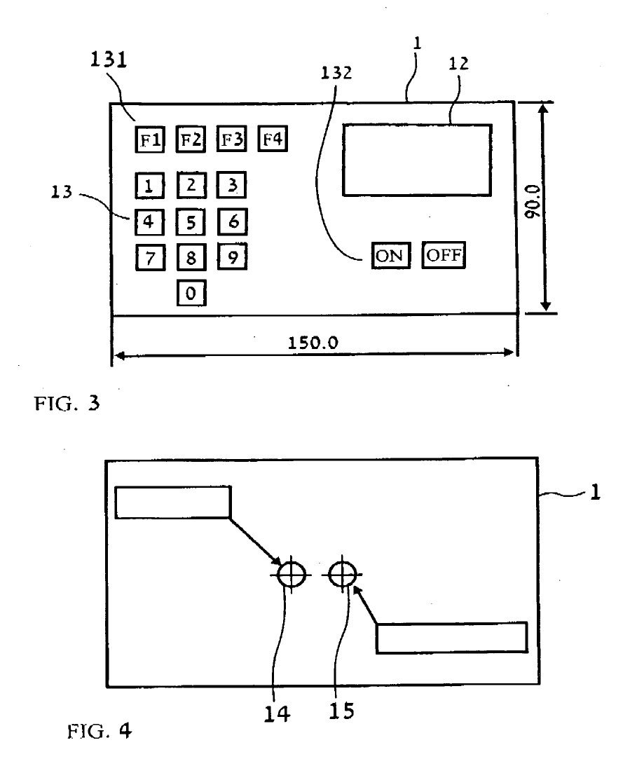

FIG. 3 describes a front view of the control board 1 for the taxi's digital display. The designated measurements are in millimeters (90*150) and this is only one example of the size of the device.

The control board includes a control unit, controlling the display on the taxi's roof, a keypad 13 (and/or buttons) for entering the driver's commands, a display for the driver 12. It may be possible to include designated buttons 131 and turn on/off buttons 132.

FIG. 4 details a rear view of the control board 1 for the taxi's digital display. The designated measurements are in millimeters and this is only one example of the size of the device. The board may also include electrical wire outputs to a battery 14, and electrical wire outputs to the display on the roof (the digital hat) 15.

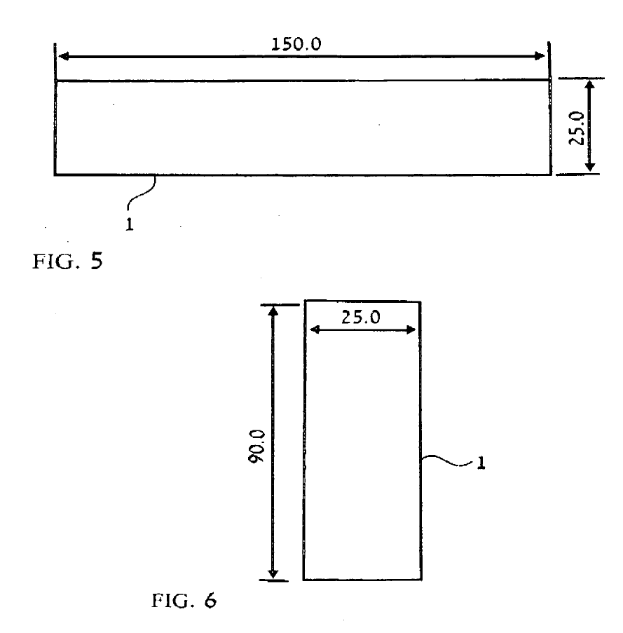

FIG. 5 details a top view of the control board 1 for the taxi's digital display and FIG. 6 details a side view of the control board for the taxi's digital display

Various modifications and various versions for implementing the invention will become apparent to a professional in the field upon reading the application described hereinbefore.

As depicted in FIG. 2, the display unit 2 installed on the taxi's roof includes the unit installed today on the taxi's roof (the yellow hat with “TAXI” writing) in which there are two types of displays:
A. A fixed written/engraved display on the yellow hat, which includes for example:
   a display 21 identifying the vehicle as a taxi and an identification of the station to which the taxi is related;
   Identification of the taxi carrying this sign 23
B. A changing electrical display according to need:
   Destination of the travel 22
   Distress signs and calling for help indications (described in the text, not shown in the drawing);
   Various additional ads may be presented through this display (described in the text).

Many benefits are provided, such as:
1. Lower price—it is not required to replace the existing unit on the roof and it is not required to install a new unit.
2. Aerodynamic formation of the roofed unit—for saving fuel. The aerodynamic shape of the existing unit is utilized, and an electronic unit is added which does not impair this attribute.
3. Prevention of fraud or impersonation—if the display and the identification are all electronic, a delinquent might exploit this for impersonating to a taxi whenever desired, and to easily clear the evidence by erasing the screen. Once he would present as if belonging to other station, once presenting that he is from a different town, or change the taxi's identification number freely.

A fixed print of the abovementioned details prevents performing these contraventions easily.

1. A taxi sign device comprised of the display unit placed on the taxi's roof, a keypad and/or buttons for entering the driver's commands, a control unit controlling the display on the taxi's roof according to the commands entered through the keypad and a driver's display, wherein the display unit which is placed on the taxi's roof utilizes the unit which is installed today on the taxi's roof (the yellow hat with the writing “TAXI”).

2. The taxi sign device according to claim 1, wherein the sign device is connected to the vehicle's battery or to other electric power source in the vehicle.

3. The taxi sign device according to claim 1, further including means which allow the driver to see status reports or to see an image of what is shown in display on the roof.

4. The taxi sign device according to claim 1, wherein the display unit placed on the taxi's roof further includes a display identifying the vehicle as a taxi, and an identification of the taxis station to which the taxi belongs.

5. The taxi sign device according to claim 1, wherein the display unit placed on the taxi's roof further includes the travel's destination.

6. The taxi sign device according to claim 1, wherein the display unit placed on the taxi's roof further includes identification means of the taxi.

7. The taxi sign device according to claim 1, wherein the display unit placed on the taxi's roof further includes means for displaying distress signs and calling for help.

8. The taxi sign device according to claim 1, wherein the display unit placed on the taxi's roof further includes digital display means.

9. The taxi sign device according to claim 8, wherein the digital display means include Light Emitting Diodes (LED), CRT, Plasma or LCD.

10. A taxi sign device comprised of the display unit placed on the taxi's roof, input means for entering the driver's commands, a control unit controlling the display on the taxi's roof according to the commands entered through the input means, wherein the display unit which is placed on the taxi's roof utilizes the unit which is installed today on the taxi's roof (the yellow hat with the writing “TAXI”), and wherein the display unit on the taxi's roof further includes a fixed display which is not changeable.

11. The taxi sign device according to claim 10, wherein the fixed display includes the taxi's number or the taxi's identification or the taxi station's identification.

12. The taxi sign device according to claim 10, further including means which allow the driver to see status reports or to see an image of what is shown in display on the roof, through an internal display within the taxi.

13. The taxi sign device according to claim 10, wherein the display unit placed on the taxi's roof further includes a display identifying the vehicle as a taxi, and an identification of the taxis station to which the taxi belongs.

14. The taxi sign device according to claim 10, wherein the display unit placed on the taxi's roof further includes the travel's destination.

15. The taxi sign device according to claim 10, wherein the display unit placed on the taxi's roof further includes means for displaying distress signs and calling for help.

16. The taxi sign device according to claim 10, wherein the display unit placed on the taxi's roof further includes digital display means.

17. The taxi sign device according to claim 16, wherein the digital display means include Light Emitting Diodes (LED), CRT, Plasma or LCD.
